(19) United States
(12) Patent Application Publication
(10) Pub. No.: US 2014/0056325 A1
(43) Pub. Date: Feb. 27, 2014

(54) DUAL THERMISTOR REDUNDANT TEMPERATURE SENSOR

(71) Applicants: Paul Guerra, Los Gatos, CA (US); Byron Reynolds, Gilroy, CA (US)

(72) Inventors: Paul Guerra, Los Gatos, CA (US); Byron Reynolds, Gilroy, CA (US)

(73) Assignee: Velomedix, Inc., Menlo Park, CA (US)

(21) Appl. No.: 13/980,378

(22) PCT Filed: Jan. 26, 2012
(86) PCT No.: PCT/US12/22757

§ 371 Date: Oct. 25, 2013

Related U.S. Application Data
(60) Provisional application No. 61/436,540, filed on Jan. 26, 2011.

(51) Int. Cl. G01K 15/00

(52) U.S. Cl. CPC G01K 15/002
USPC 374/1

(57) ABSTRACT

A redundant temperature measurement probe is described that may include any number of features. In one embodiment, the probe includes a pair of resistive sensors, a pair of output wires, and a shared ground wire for a total of three wires. The first and second resistive sensors of the probe can be electrically connected to a controller to measure temperature and detect when a fault in the probe occurs. In some embodiments, the controller can be configured to detect a shift in resistance

### CROSS REFERENCE TO RELATED APPLICATIONS

This application claims the benefit under 35 U.S.C. 119 of U.S. Provisional Patent Application No. 61/436,540, filed Jan. 26, 2011, titled “Dual Thermistor Redundant Temperature Sensor”. This application is herein incorporated by reference in its entirety.

### INCORPORATION BY REFERENCE

All publications and patent applications mentioned in this specification are herein incorporated by reference to the same extent as if each individual publication or patent application was specifically and individually indicated to be incorporated by reference.

### FIELD

This disclosure generally relates to temperature sensors. More specifically, this disclosure relates to dual thermistor temperature sensors that provide redundant temperature measurement.

### BACKGROUND

Temperature sensor redundancy is critical to safe operation of some devices, particularly in the field of medical devices where measurement of temperature within the body of a patient can be critical to patient safety.

Often, two independent resistive sensors are used with two wires to each sensor for a total of four wires. A two-sensor/four-wire design enables the system/user to detect a break in any of the wires, and also shifts in impedance within any wire or connection that causes a shift in calibration. Additional wires can increase the cost and size of a device, making them not acceptable for some applications.

The invention provides a way to have a two-sensor/three-wire device with no compromise in the ability to detect open circuits and shifts in impedance.

### SUMMARY OF THE DISCLOSURE

A redundant temperature measurement system, comprising a probe having first sensor connected to a first output wire, a second sensor connected to a second output wire, and a shared ground wire connected to both the first and second sensors, and a controller configured to receive temperature information from the first and second sensors via the first and second output wires, the controller configured to detect a shift in resistance of the shared ground wire.

In some embodiments, the first and second sensors comprise resistive sensors.

In one embodiment, the first resistive sensor has a first resistance, and the second resistive sensor has a second resistance different than the first resistance.

In some embodiments, the controller detects a shift in resistance of the shared ground wire when temperature information from the first sensor differs from temperature information from the second sensor by an amount greater than a fault threshold.

In some embodiments, the controller comprises a first signal conditioner electrically coupled to the first sensor, a second signal conditioner electrically coupled to the second sensor, and a comparator coupled to the first and second signal conditioners.

In one embodiment, the comparator detects a shift in resistance of the shared ground wire when temperature information from the first sensor differs from temperature information from the second sensor by an amount greater than a fault threshold.

In additional embodiments, the temperature information comprises a first temperature measured by the first sensor and a second temperature measured by the second sensor.

In one embodiment, the probe is coupled to the controller with exactly three wires.

A method of measuring temperature, comprising measuring a temperature of a target location with a temperature probe having first and second sensors connected to a first output wire, a second output wire, and a shared ground wire, transmitting temperature information from the first and second temperature sensors to a controller, and detecting a shift in resistance of the shared ground wire when temperature information from the first temperature sensor differs from temperature information from the second sensor by an amount greater than a fault threshold.

In some embodiments, the measuring step comprises measuring the temperature of the target location with first and second resistive sensors.

In another embodiment, the first resistive sensor has a first resistance, and the second resistive sensor has a second resistance different than the first resistance.

In one embodiment, the method comprises detecting the shift in resistance of the shared ground wire with a comparator.

In another embodiment, the temperature information comprises a first temperature measured by the first sensor and a second temperature measured by the second sensor.

In some embodiments, the probe comprises exactly three wires.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is a schematic drawing of a redundant dual thermistor temperature system.

FIG. 2 illustrates the transfer curves of Temperature vs. Resistance for a pair of resistive sensors in the redundant temperature sensor system of FIG. 1.

### DETAILED DESCRIPTION OF THE DISCLOSURE

This disclosure describes embodiments of a temperature sensor having two resistive sensors with different characteristics for providing redundant temperature measurements while sharing a common ground wire. The three-wire temperature sensors described herein can be used to provide redundant temperature measurements with the ability to detect faults, breaks in the wires, or drifts in impedance in any of the wires of the sensors or in the connectors to the temperature sensors.

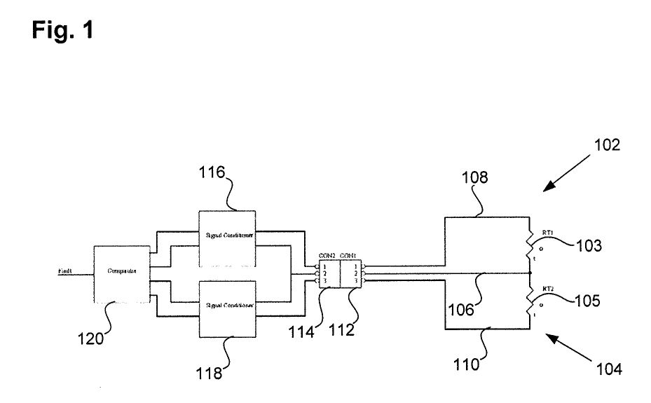

In FIG. 1, a temperature sensor system 100 is shown including resistive temperature sensors or thermistors 102 and 104 having resistive elements 103 and 105, respectively.

Temperature sensors 102 and 104 share a common wire or common ground wire 106. Sensor 102 includes an output wire 108, and sensor 104 includes an output wire 110. The temperature sensors 102 and 104 are electrically connected to connectors 112 and 114, which are further connected to signal conditioners 116 and 118 and then connected to comparator 120. The signal conditioners 116 and 118 and comparator 120 can be collectively referred to herein as a controller.

The system design illustrated in FIG. 1 includes two resistive sensors 102 and 104 that have different resistance characteristics and share a common ground wire. Each channel/sensor can be calibrated independently, and the output of each channel can then be compared for redundancy.

The system is configured to detect faults (e.g., open circuits) or shifts in impedance that may occur during use. Open circuits can be easily detected as there is no signal on one or both channels, depending on the wire or connection that breaks. Shifts in impedance in either of the two output wires would affect calibration and be detected as a difference in the measurement between the original calibrated measurements. Shifts in impedance in the common wire create differing amounts of change in each of the sensor channels due to the difference in resistance characteristics, making a detectable event.

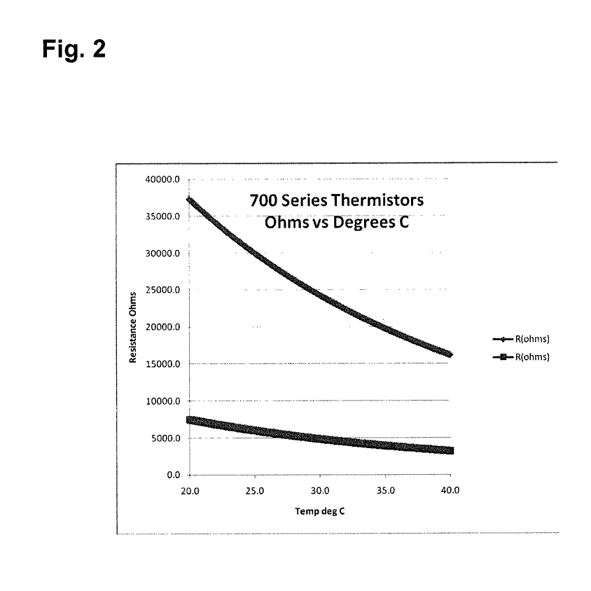

FIG. 2 illustrates the transfer curves of Temperature vs. Resistance for a pair of resistive sensors in the redundant temperature sensor system of FIG. 1. The values of resistive elements 103 and 105 can be chosen so that the transfer curves for the two thermistors have no overlapping regions. For example, in the embodiment shown in FIG. 2, resistive element 103 can range from 3,100 to 7,500 ohms, and resistive element 105 can range from 16,200 to 37,300 ohms in the temperature range of 20-40° C. As shown, the resistive elements can be chosen to provide a linear transfer curve between temperature and resistance.

In use, for every temperature in the area of interest, the temperature measured by the first channel (e.g., sensor 102) can be compared to the temperature measured by the second channel (e.g., sensor 104), followed by verification that the second channel measurement is within the appropriate measurement range. If the second measurement is within the appropriate range, its reading can be included in the temperature calculation. If the measurement is not in range (say, for example, within 1° C.), the temperature sensor system can provide a fault signal.

Referring back to FIG. 1, the two temperature sensors can include a total of three signal wires; common wire 106, output 108, and output 110. If common wire 106 is open or shorted to either output, the system can detect it. If output 108 is open or shorted to ground, the system can detect it. If output 110 is open or shorted to ground, the system can detect it.

If output 108 has a partially resistive connection, it will shift the reading and the system can detect it. Similarly, if output 110 has a partially resistive connection, it will shift the reading and the system can detect it.

If common wire 106 has a partially resistive connection or a shift in resistance, it will create the same resistance shift on both channels. This is the type of fault that cannot currently be detected with other temperature probes on the market which utilize a pair of thermistors with a total of four wires. The reason is that the resistance shift results in the same magnitude error on both channels because both channels have the same resistance thermistors.

With the redundant temperature sensor system shown in FIG. 1, the two thermistors 102 and 104 have different resistance versus temperature relationships, so this failure mode on the ground wire becomes detectable since a resistance shift on the ground wire results in a different magnitude error on each of the thermistors. Thus, in the embodiment of FIG. 1, the signal conditioners 116 and 118 and comparator 120 (also referred to collectively as a controller) are configured to detect a shift in resistance on common wire 106 since a change in resistance on the common wire results in a different magnitude shift in the conditioned signal from the two thermistors.

In some embodiments, the controller is configured to detect a shift in resistance of the common ground wire when a change in temperature measurements between the first and second sensors is greater than a pre-determined fault threshold. For example, in one embodiment a pre-determined fault threshold can be 1° C., so in this example the controller can be configured to detect a fault condition on the common wire when the difference between temperature measurements on the first and second sensors is greater than 1° C. When the difference between the measured temperatures exceeds the fault threshold, the controller (e.g., the comparator in some embodiments) can indicate that a fault condition has occurred.

The following example describes fault detection with the temperature sensor system 100 of FIG. 1.

Example 1: In a Patient having a temperature of 37° C., sensor 102 reads 18,204.9 ohms and sensor 104 reads 3,609.24 ohms. A ground fault introducing a 500 ohm resistance occurs. Because of the ground fault, sensor 102 now reads 18,704.9 ohms creating a reading around 36.35° C. Sensor 104 now reads 4,109.24 ohms creating a reading around 33.9° C. The delta between the two sensors=2.45° C. This provides a detectable fault if the system is configured to alert to a fault condition when the delta is, for example, greater than 1° C.

Example 2: In a Patient having a temperature of 30° C., sensor 102 reads 24,268.0 ohms, and sensor 104 reads 4,833.87 ohms. A ground fault introducing a 500 ohm resistance occurs. Because of the ground fault, sensor 102 now reads 24768 ohms or around 29.5° C. Sensor 104 now reads 5,333.87 ohms or around 27.7° C. The delta between the two sensors=1.8° C. This provides a detectable fault if the system is configured to alert to a fault condition when the delta is, for example, greater than 1° C.

Table 1 describes ways that all potential failure modes can be detected with the system of FIG. 1.

TABLE 1

| Condition | Detectable Event |
|---|---|
| Open circuit between thermistor | Resistance of thermistor 103 becomes infinite. |
| 103 and connector 112, pin 1 | Comparator faults due to out of range input. |
| Open circuit between thermistors | Resistance of thermistor 103 and thermistor 105 becomes |
| 103/105 and connector 112, pin 2 | infinite. |
| | Comparator faults due to out of range input. |
| Open circuit between thermistor | Resistance of thermistor 105 becomes infinite. |
| 105 and connector 112, pin 3 | Comparator faults due to out of range input. |
| Short circuit between connector | Resistance of thermistor 103 becomes zero. Comparator |
| 112, pin 1 and connector 112, pin 2 | faults due to out of range input. |
| Short circuit between connector | Resistance of thermistor 105 becomes zero. Comparator |
| 112, pin 2 and connector 112, pin 3 | faults due to out of range input. |
| Short circuit between connector | Resistance of thermistor 103 and thermistor 105 become |
| 112, pin 1 and connector 112, pin 3 | the same. Conditioned signal from thermistor 103 |
| | (temperature conversion) no longer sufficiently matches |
| | conditioned signal from thermistor 105 (temperature |
| | conversion) and the comparator signals a fault. |
| Resistance increases between | Resistance is added to thermistor 103. When conditioned |
| connector 112, pin 1 and connector | signal from thermistor 103 (temperature conversion) no |
| 114, pin 1 | longer sufficiently matches conditioned signal from |
| | thermistor 105 (temperature conversion), the comparator |
| | signals a fault. |
| Resistance increases between | The same resistance is added to thermistor 103 and |
| connector 112, pin 2 and connector | thermistor 105. The effect of this resistance results in a |
| 114, pin 2 | different magnitude shift in the conditioned signal |
| | (temperature conversion). When conditioned signal from |
| | thermistor 103 no longer sufficiently matches the |
| | conditioned signal from thermistor 105, comparator |
| | signals a fault. |
| Resistance increases between | Resistance is added to thermistor 103. When conditioned |
| connector 112, pin 3 and connector | signal from thermistor 103 no longer sufficiently matches |
| 114, pin 3 | the conditioned signal from thermistor 105, the |
| | comparator signals a fault. |

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

What is claimed is:

1. A redundant temperature measurement system, comprising:
a probe having first sensor connected to a first output wire, a second sensor connected to a second output wire, and a shared ground wire connected to both the first and second sensors; and
a controller configured to receive temperature information from the first and second sensors via the first and second output wires, the controller configured to detect a shift in resistance of the shared ground wire.

2. The system of claim 1 wherein the first and second sensors comprise resistive sensors.

3. The system of claim 2 wherein the first resistive sensor has a first resistance, and the second resistive sensor has a second resistance different than the first resistance.

4. The system of claim 1 wherein the controller detects a shift in resistance of the shared ground wire when temperature information from the first sensor differs from temperature information from the second sensor by an amount greater than a fault threshold.

5. The system of claim 1 wherein the controller comprises a first signal conditioner electrically coupled to the first sensor, a second signal conditioner electrically coupled to the second sensor, and a comparator coupled to the first and second signal conditioners.

6. The system of claim 1 wherein the comparator detects a shift in resistance of the shared ground wire when temperature information from the first sensor differs from temperature information from the second sensor by an amount greater than a fault threshold.

7. The system of claim 1 wherein the temperature information comprises a first temperature measured by the first sensor and a second temperature measured by the second sensor.

8. The system of claim 1 wherein the probe is coupled to the controller with exactly three wires.

9. A method of measuring temperature, comprising:
measuring a temperature of a target location with a temperature probe having first and second sensors connected to a first output wire, a second output wire, and a shared ground wire;
transmitting temperature information from the first and second temperature sensors to a controller; and
detecting a shift in resistance of the shared ground wire when temperature information from the first temperature sensor differs from temperature information from the second sensor by an amount greater than a fault threshold.

10. The method of claim 9 wherein the measuring step comprises measuring the temperature of the target location with first and second resistive sensors.

11. The method of claim 10 wherein the first resistive sensor has a first resistance, and the second resistive sensor has a second resistance different than the first resistance.

12. The method of claim 9 further comprising detecting the shift in resistance of the shared ground wire with a comparator.

13. The method of claim 9 wherein the temperature information comprises a first temperature measured by the first sensor and a second temperature measured by the second sensor.

14. The method of claim 9 wherein the probe comprises exactly three wires.
